(19) United States
(12) Patent Application Publication
(10) Pub. No.: US 2004/0221422 A1
(43) Pub. Date: Nov. 11, 2004

(54) Mechanical pencil with double screw eraser adjustment

(76) Inventor: Han Aiguo, Shanghai (CN)

Correspondence Address: DICKSTEIN SHAPIRO MORIN & OSHINSKY LLP, 2101 L STREET NW, WASHINGTON, DC, 20037-1526, US

(21) Appl. No.: 10/431,391

(22) Filed: May 8, 2003

(51) Int. Cl. B43K 29/02; B43L 19/00

(52) U.S. Cl. 15/426; 15/429; 15/433

(57) ABSTRACT

An eraser advancing mechanism for a mechanical pencil has a pair of nested screws within a barrel. A second screw, with outwardly directed threads, extends through a conduit in a first screw that includes outwardly directed threads and a thread in the conduit meshing with the threads of the second screw. An eraser ferrule includes a thread that meshes with the outwardly directed threads of the first screw. The ferrule includes a knob serving to drive rotation of the eraser ferrule, and hence the first screw. The first screw includes a head with a profile that complements the inner profile of the barrel. Rotation of the first screw causes rotation of the barrel and serves to create a counter-rotation of the second screw, leading to axial movement of the second screw relative to the first screw.

### FIELD OF THE INVENTION

The present invention relates generally to the field of mechanical pencils, and more particularly to eraser advancing mechanisms for use within mechanical pencils.

### BACKGROUND

Mechanical pencils are well known. Various examples of mechanical pencils have been introduced. For example, see U.S. Pat. No. 1,236,331 (Manuel), U.S. Pat. No. 2,286,878 (Tefft et al.), U.S. Pat. No. 2,613,644 (Hansen), and U.S. Pat. No. 5,018,891 (Kageyama et al.).

With reference to FIG. 1, a conventional mechanical pencil 10 is illustrated. The pencil 10 includes a barrel 12, a screw 14, an eraser ferrule 22 holding an eraser 20 and including a knob 24, and a clip base 26. The screw 14 includes outwardly directed threads 16 along a shaft and a screw fork 18 at one end. The screw fork 18 fits within the eraser ferrule 22 and assists in retaining the eraser 20. The clip base 26 includes a conduit 27 through which the screw 14 extends. A clip base thread 28 extends radially inwardly in the conduit 27 and meshes with the screw threads 16.

Rotation of the knob 24 leads to rotation of the screw 14. Specifically, the screw fork 18 fits within a recess (not shown) of the eraser ferrule 22, and rotation of the knob 24 and the eraser ferrule 22 causes rotation of the screw fork 18. Rotation of the screw 14 leads to an axial movement of the screw 14. The screw threads 16 are meshed with the clip base thread 28, and since the clip base 26 remains stationary, the screw 14 moves axially in a direction along the longitudinal axis A of the mechanical pencil 10.

Refer now to FIG. 2, which illustrates another known mechanical pencil 50. The pencil 50 includes a barrel 52, an eraser ferrule 58 holding an eraser 56 and including a knob 66, and a clip base 68. Within the eraser ferrule is a mounting portion 54 upon which the eraser 56 is mounted within the eraser ferrule 58. The eraser ferrule 58 includes a base portion 64, upon which the mounting portion 54 is positioned, and a flange 62 engaging with a ledge 72 of the clip base 68.

The eraser ferrule 58 further includes radially inwardly directed threads 60 which mesh with radially outwardly directed threads 70 of the mounting portion 54. As the knob 66 is rotated, the threads 60 of the eraser ferrule 58 mesh with the threads 70 of the mounting portion 54 to axially move the mounting portion 54, and hence the eraser 56, in a direction of the longitudinal axis A.

Several undesirable aspects are found in known mechanical pencils. Mechanical pencils that utilize a single screw structure, as shown in FIGS. 1 and 2, have less internal space for housing the pencil lead and pencil lead advancing mechanism. Further, mechanical pencils that utilize a single screw structure have only a direct one-to-one correlation between the distance the knob is turned and the distance the eraser is moved in response.

### SUMMARY

The present invention provides an eraser advancing mechanism that includes a barrel, a first screw disposed within the barrel and having outer threads and a conduit, a second screw nested within the first screw and having threads, and an eraser ferrule connected to the first screw. The second screw extends into the eraser ferrule and the eraser ferrule is adapted to drive rotation of the first and second screws.

The present invention further provides an eraser advancing mechanism that includes a barrel, a first screw disposed within the barrel and having outer threads and a conduit, a second screw nested within the first screw and having threads, an eraser ferrule connected to the first screw and having a knob adapted to drive rotation of the first and second screws, and a clip base mounted between the barrel and the eraser ferrule. Rotation of the eraser ferrule a first distance in a first direction drives rotation of the first screw the first distance in the first direction and drives rotation of the second screw the first distance in a second direction opposite from the first direction, thereby leading to an axial movement of the second screw.

The present invention also provides a mechanical pencil that includes a barrel, a clip base mounted on the barrel, a first screw disposed within the barrel and having outer threads and a conduit, a second screw having threads nested within the first screw, an eraser ferrule having a knob and being connected to the first screw. The knob serves to drive rotation of the first screw and the second screw. The clip base is positioned between the barrel and the knob.

These and other advantages and features of the invention will be more readily understood from the following detailed description of the invention which is provided in connection with the accompanying drawings.

### BRIEF DESCRIPTION OF THE DRAWINGS

FIG. 1 is a cross-sectional view of a portion of a known mechanical pencil.

FIG. 2 is a cross-sectional view of a portion of another known mechanical pencil.

FIG. 3 is a cross-sectional view of a portion of a mechanical pencil constructed in accordance with an embodiment of the invention.

FIG. 4 is a partial cross-sectional view of the second screw of FIG. 3.

FIG. 5 is an end view of the second screw of FIG. 3.

FIG. 6 is a partial cross-sectional view of the eraser ferrule of FIG. 3.

FIG. 7 is a cross-sectional view taken along line VII-VII of FIG. 6.

FIG. 8 is an end view of the eraser ferrule of FIG. 3.

FIG. 9 is a cross-sectional view of a first preferred embodiment of the barrel of FIG. 3.

FIG. 10 is a cross-sectional view taken along line X-X of FIG. 9.

FIG. 11 is an end view of a first preferred embodiment of the first screw of FIG. 3 for use with the barrel of FIG. 9.

FIG. 12 is a partial cross-sectional view of the screw of FIG. 11.

FIG. 13 is a cross-sectional view of a second preferred embodiment of the barrel of FIG. 3.

FIG. 14 is a cross-sectional view taken along line XIV-XIV of FIG. 13.

FIG. 15 is a partial cross-sectional view of a second preferred embodiment of the first screw of FIG. 3 for use with the barrel of FIG. 13.

FIG. 16 is an end view of the screw of FIG. 15.

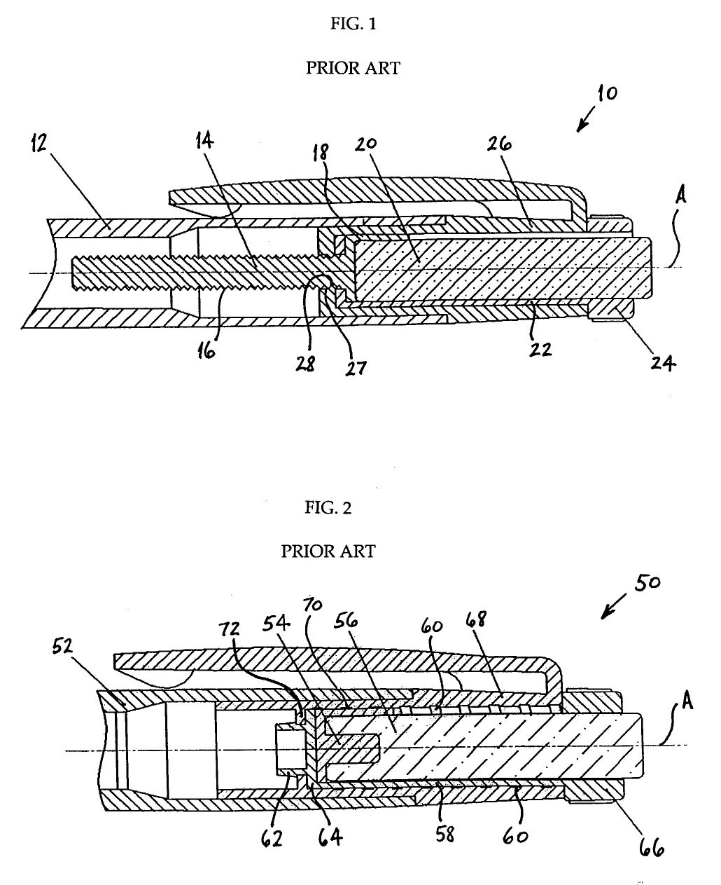

### DETAILED DESCRIPTION OF PREFERRED EMBODIMENTS

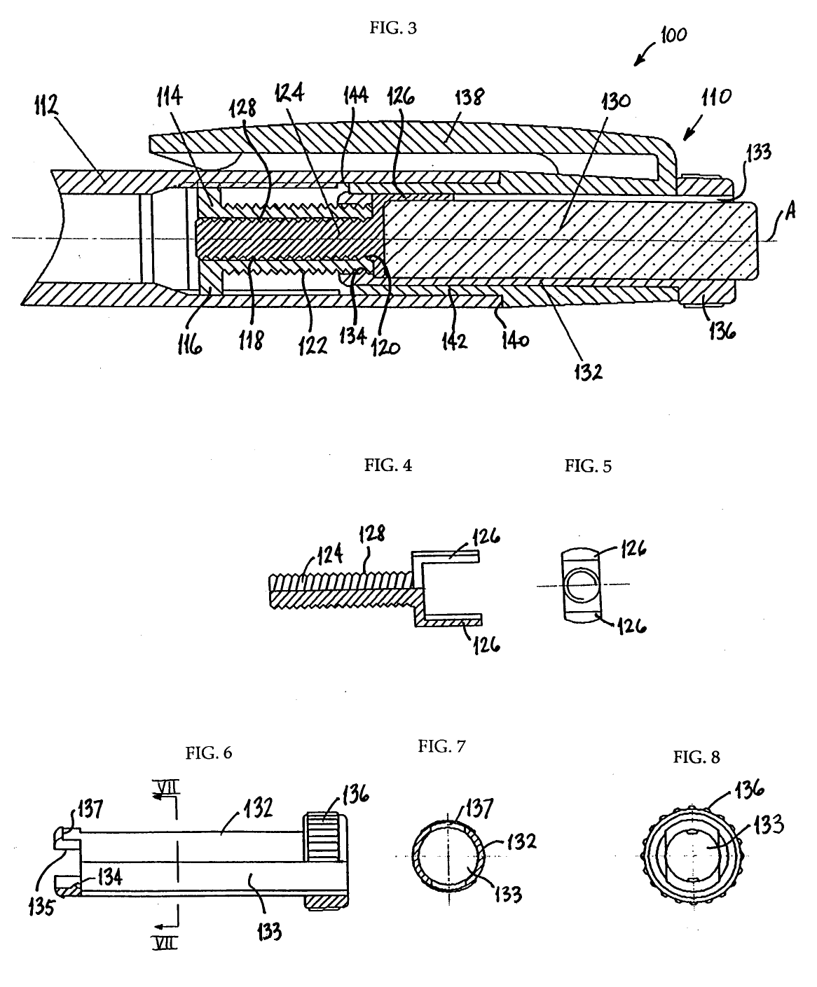

Referring to FIGS. 3-8, there is shown a mechanical pencil 100 that includes an eraser advancing mechanism 110. The eraser advancing mechanism 110 includes a barrel 112, a first screw 114, a second screw 124, an eraser 130, an eraser ferrule 132, and a clip base 138. The clip base 138 is mounted between the eraser ferrule 132 and the barrel 112. The first screw 114 is suitably shaped to fit within the barrel 112 such that the first screw 114 is inhibited from rotating within the barrel 112. The first screw 114 includes a screw head 116, a conduit 118 extending through a longitudinal axis of the first screw 114, and radially outwardly directed threads 122. The conduit 118 also includes a radially inwardly directed thread 120.

The second screw 124 (FIGS. 3-5) is nested within the first screw 114 and extends through the conduit 118 of the first screw 114. The second screw 124 includes radially outwardly directed threads 128 as well as a fork 126. The second screw threads 128 mesh with the conduit thread 120, thereby allowing relative movement between the first and second screws 114, 124.

The screw fork 126 extends into the ferrule opening 133 of the eraser ferrule 132. The eraser ferrule 132 includes a flange 135 that has a radially inwardly directed thread 134 which meshes with the first screw threads 122. The clip base 138 contacts with the barrel 112 at a ledge 140 and has a tube 142 that extends beyond the ledge 140 into the barrel 112. The tube 142 ends at a tube end 144, which abuts the ferrule flange 135 at a flange ledge 137 (FIGS. 3 and 6).

The eraser ferrule 132 further includes a rotatable knob 136, and rotation of the knob 136 causes rotation of the eraser ferrule 132. Since the first screw 114 is inhibited from rotational movement, due to the meshing between the thread 134 and the outer threads 122, the first screw 114 moves axially along a longitudinal axis A of the mechanical pencil 100. The outer threads 128 of the second screw 124 are in a different direction than the threads 122. For example, if the threads 122 are right-hand threads, the outer threads 128 would be left-hand threads. Thus, as the first screw 114 moves axially, the meshing between the inner thread 120 of the first screw 114 and the outer threads 128 of the second screw 124 causes the second screw 124 to rotate in the same direction as the knob 136 and the eraser ferrule 132. For example, if the knob 136 causes a clockwise rotation of the eraser ferrule 132, the second screw 124 also rotates in a clockwise direction. Rotation of the second screw 124 causes axial movement of the second screw 124 relative to the first screw 114. Further, rotation of the second screw 124 causes axial movement of the eraser 130, which is fitted within the fork 126 of the second screw 124, in a direction along the longitudinal axis A of the mechanical pencil 100.

Through this arrangement, the nesting of the first and second screws 114 and 124 provides greater room within the mechanical pencil 100 for pencil lead and the pencil lead advancing mechanism than in known single screw arrangements. Further, this arrangement enables axial movement of the eraser 130 at a greater rate than in conventional mechanical pencils. Specifically, if the knob 136 is rotated, for example, one-quarter turn, the eraser 130 is enabled to move a greater distance than an eraser in a known single screw arrangement would move in response to a quarter turn by the knob.

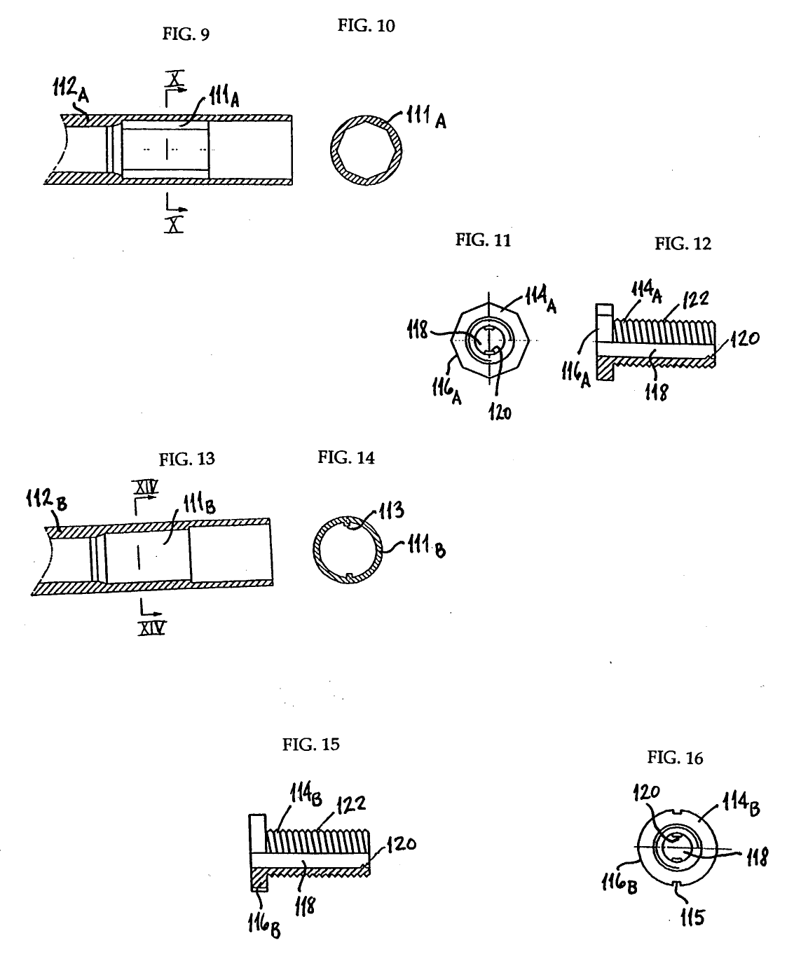

The barrel 112 and the head 116 have complementary shapes to allow the barrel 112 and the first screw 114 to rotate together. Refer now to FIGS. 9-12, in which a first preferred embodiment of the barrel 112 and the first screw 114 is illustrated. As shown, the barrel, denoted in FIGS. 9 and 10 by the reference numeral 112_{A}, has a portion 111_{A} with an octagonal inner profile. Also as shown, the first screw, denoted in FIGS. 11 and 12 by the reference numeral 114_{A} includes a screw head 116_{A} with eight sides which complement the octagonal inner profile portion 111_{A} of the barrel 112_{A}. By placing the first screw 114_{A} within the barrel portion 111_{A}, the first screw 114_{A} is inhibited from rotational movement.

Refer now to FIGS. 13-16, in which a second preferred embodiment of the barrel 112 and the first screw 114 is illustrated. As shown, the barrel, denoted in FIGS. 13 and 14 by the reference numeral 112_{B}, has a portion 111_{B} with a circular inner profile and a pair of opposing inwardly protruding guide bars 113. Also as shown, the first screw, denoted in FIGS. 15 and 16 by the reference numeral 114_{B} includes a screw head 116_{B} with a circular profile which is complementary to the circular inner profile portion 111_{B} of the barrel 112_{B}. The screw head 116_{B} further includes a pair of opposing outwardly facing guide slots 115. By placing the first screw 114_{B} within the barrel portion 111_{B} such that the guide bars 113 are received within the guide slots 115, the first screw 114_{B} is inhibited from rotating. It should be appreciated that, alternatively, the guide bars 113 can be disposed on the screw head 116_{B} and the guide slots 115 can be positioned on the barrel portion 111_{B}.

While the invention has been described in detail in connection with exemplary embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, while an octagonal inner profile for the barrel portion 111_{A} has been described and illustrated, it should be appreciated that other suitable inner profiles for the barrel, which complement the profile of the first screw head 116, may be utilized, including inner profiles having three to seven sides or greater than eight sides. Accordingly, the invention is not to be seen as limited by the foregoing description, but is only limited by the scope of the appended claims.

What is claimed as new and desired to be protected by Letters Patent of the United States is:

1. An eraser advancing mechanism, comprising:
a barrel;
a first screw disposed within said barrel and having outer threads and a conduit;
a second screw nested within said first screw, said second screw comprising threads; and
an eraser ferrule connected to said first screw and adapted to drive rotation of said second screw.

2. The eraser advancing mechanism of claim 1, wherein rotation of said eraser ferrule causes axial movement of said first screw relative to said barrel.

3. The eraser advancing mechanism of claim 1, further comprising a clip base mounted between said barrel and said eraser ferrule.

4. The eraser advancing mechanism of claim 1, wherein said first screw comprises an inner thread in said conduit, said inner thread meshing with said threads of said second screw.

5. The eraser advancing mechanism of claim 1, wherein said eraser ferrule includes a thread adapted to mesh with said outer threads of said first screw.

6. The eraser advancing mechanism of claim 1, wherein said first screw comprises a head and said barrel comprises an inner profile complementary to said head.

7. The eraser advancing mechanism of claim 6, wherein said barrel inner profile is an octagon, said head of said first screw comprising eight sides.

8. The eraser advancing mechanism of claim 6, wherein said barrel inner profile is generally circular and wherein the eraser advancing mechanism comprises a pair of opposing guide bars and a pair of opposing guides slots, each said guide bar adapted to be received in a respective one of said guide slots.

9. The eraser advancing mechanism of claim 8, wherein said barrel comprises said pair of opposing guide bars, said head of said first screw comprising said pair of opposing guide slots.

10. The eraser advancing mechanism of claim 1, wherein rotation of said eraser ferrule in a first direction drives rotation of said second screw in said first direction.

11. The eraser advancing mechanism of claim 1, wherein said second screw comprises a fork extending into said eraser ferrule and adapted to retain an eraser within said eraser ferrule.

12. An eraser advancing mechanism, comprising:
a barrel;
a first screw disposed within said barrel and having outer threads and a conduit;
a second screw nested within said first screw and comprising threads;
an eraser ferrule connected to said first screw and comprising a knob adapted to drive rotation of said second screw; and
a clip base mounted between said barrel and said eraser ferrule;
wherein rotation of said knob in a first direction drives axial movement of said first screw relative to said barrel and drives rotation of said second screw in said first direction, thereby leading to an axial movement of said second screw.

13. The eraser advancing mechanism of claim 12, wherein said clip base comprises a ledge which mounts against an end of said clip base.

14. The eraser advancing mechanism of claim 12, wherein said first screw comprises an inner thread in said conduit, said inner thread meshing with said threads of said second screw.

15. The eraser advancing mechanism of claim 14, wherein said eraser ferrule includes a thread adapted to mesh with said outer threads of said first screw.

16. The eraser advancing mechanism of claim 15, wherein said first screw comprises a head and said barrel comprises an inner profile complementary to said head.

17. A mechanical pencil, comprising:
first and second mechanical devices, said second device being nested within said first device, said second screw comprising threads;
a third device, connected to said first device, for rotating said second device; and
an eraser disposed in said third device.

18. The mechanical pencil of claim 17, wherein said first device comprises an inner thread meshing with said second device.

19. The mechanical pencil of claim 17, wherein said third device includes a thread adapted to mesh with said first device.
